(19) United States
(12) Patent Application Publication
(10) Pub. No.: US 2013/0179701 A1
(43) Pub. Date: Jul. 11, 2013

(54) SEPARATE DEBUG POWER MANAGEMENT

(71) Applicant: TEXAS INSTRUMENTS INCORPORATED, Dallas, TX (US)

(72) Inventor: Gary L. Swoboda, Sugar Land, TX (US)

(73) Assignee: TEXAS INSTRUMENTS INCORPORATED, Dallas, TX (US)

(21) Appl. No.: 13/738,677

(22) Filed: Jan. 10, 2013

Related U.S. Application Data
(60) Provisional application No. 61/584,955, filed on Jan. 10, 2012.

(51) Int. Cl. G06F 1/26

(52) U.S. Cl. CPC G06F 1/26
USPC 713/300

(57) ABSTRACT

The power consumption of embedded debug functions in ultra low power SoC sytems is minimized by seggregating the debug logic into separate power domains, and allocating separate power pins to the debug power sources. Debug power may be supplied from an external power source, from the system power source or from a functional communication interface such as USB, JTAG or cJTAG.

### CLAIM OF PRIORITY

This application claims priority under 35 U.S.C. 119(e)(1) to Provisional Application No. 61584955 filed 10 Jan. 2012.

### TECHNICAL FIELD OF THE INVENTION

The technical field of this invention is power management in embedded cores.

### BACKGROUND OF THE INVENTION

Debug in SoC and electronic systems in general is a major and ongoing issue for all complex products. Most System on Chip (SoC) level ICs and an increasing number of systems include complex embedded circuitry for debug and related purposes. The types of debug circuits embedded in a system are varied and often depend both on end application and analysis requirements. Having embedded instrumentation in a design provides a major advantage and is a compliment to other analysis techniques as it allows real time visibility into the actual system, rather than just models.

In very low power SoC systems this approach presents a problem. Once the SoC debug is completed and the SoC is in use, the debug logic is no longer needed, but it will still continue to use power thus impacting the power budget of the system.

### SUMMARY OF THE INVENTION

A method is shown for minimizing power consumption in ultra low power systems after functional debug functions are no longer required. The power source for the debug functions is segregated from the system power source thus allowing independent control of power consumption by the debug logic.

### BRIEF DESCRIPTION OF THE DRAWINGS

These and other aspects of this invention are illustrated in the drawings, in which:

FIG. 1 illustrates using system power for comingled debug logic,

FIG. 2 illustrates using system power for both comingled and modular debug logic,

FIG. 3 illustrates using system power with debug power management,

FIG. 4 illustrates using an external power source for segregated debug logic,

FIG. 5 illustrates using an external power source for dedicated debug logic,

FIG. 6 illustrates using an external power source with debug power management,

FIG. 7 illustrates using the system power source for segregated debug logic,

FIG. 8 illustrates using an external power source for segregated debug logic, and

FIG. 9 illustrates powering the debug logic from an external tool managing the debug logic power.

### DETAILED DESCRIPTION OF PREFERRED EMBODIMENTS

In a system where debug functions are required, it is often desirable to collect information about system operation with software and hardware monitors. These are often supported with on-chip hardware dedicated for this purpose. In addition mechanisms using pins, output buffers and input buffers are needed to use these features. These consume some amount of power at all times.

Historically some debug functions have been collocated with functional logic and have used the same power supply. In this case debug logic always consumes power. Some debug functions have been segregated (e.g. some trace functions) with a switchable power supply powering these circuits. Although this reduces the power consumption for this logic when the power supply is off, the switchable power supply consumes some power, consumes area, and must be managed to utilize its power savings.

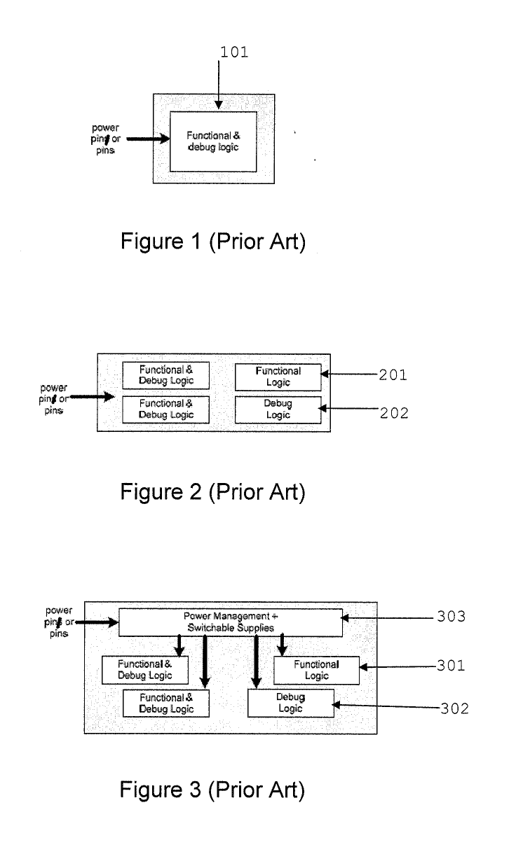

With prior art, the debug logic and its power is handled using one of the approaches shown in FIGS. 1, 2 and 3. With FIG. 1 power is supplied directly to comingled functional and debug logic 101. With FIG. 2 functional logic 201 and debug logic 202 are both comingled and separated in various modules. Power is supplied directly to these modules. With FIG. 3, functional logic 301 and debug logic 302 are both comingled and separated in various modules. These modules represent power domains. Some or all of the power management logic 303 is always powered. This logic controls switchable supplies to these power domains. Power is supplied to these domains only when their function is needed.

In each of the approaches shown in FIGS. 1 through 3 the power source for both segregated and comingled debug logic is the same pin or pins that are the power source for functional logic.

With FIG. 1 debug logic leakage current always contributes to power consumption with additional power consumed by this logic when it is being used (logic switching occurs). With FIG. 2, debug logic leakage current always contributes to power consumption with additional power consumed by this logic when it is being used (logic switching occurs). A larger percentage of switch power may be eliminated in this case. With FIG. 3 debug logic leakage current contributes to power consumption when this logic is powered, with additional power consumed by this logic when it is being used (logic switching occurs). The power switch consumes power independent of the state of debug power.

In many cases determining real power consumption during application development is difficult with these approaches. Some methods for determining of power consumption monitor the operation of on-chip components, with this statistical information gathered by an external tool. This requires the power-up of some or all of the debug logic. This can distort the result of power measuring instrumentation.

Minimizing the power consumption of every chip function is highly desirable when ultra low application power is needed. Segregating both the debug logic and the functional/debug power pins yields additional power savings over current art. This creates the SoC block diagrams shown in 4, 5 and 6.

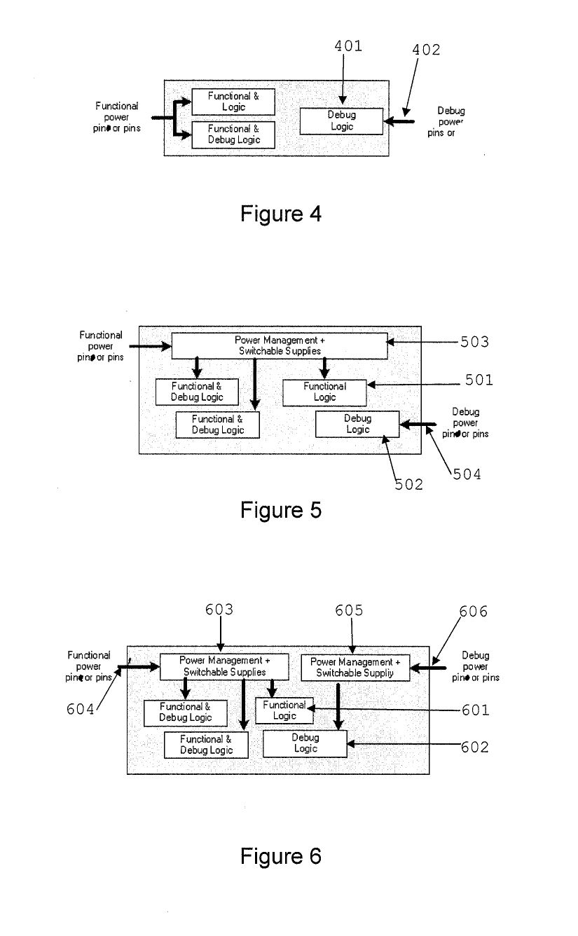

With FIG. 4 power is supplied from an external source 401 directly to segregated debug logic through a pin or pins dedicated for this purpose. With FIG. 5 functional logic 501 and debug logic 502 are both comingled and separated in various modules. Power is supplied to functional modules via power management logic 503 and directly to the debug logic through pins 504 dedicated for this purpose. With FIG. 6, functional logic 601 and debug logic 602 are both comingled and separated in various modules. Power is supplied to functional modules via power management logic 603 and pins 604 dedicated for this purpose. Power is supplied to debug modules via power management logic 605 and pins 606 dedicated for this purpose.

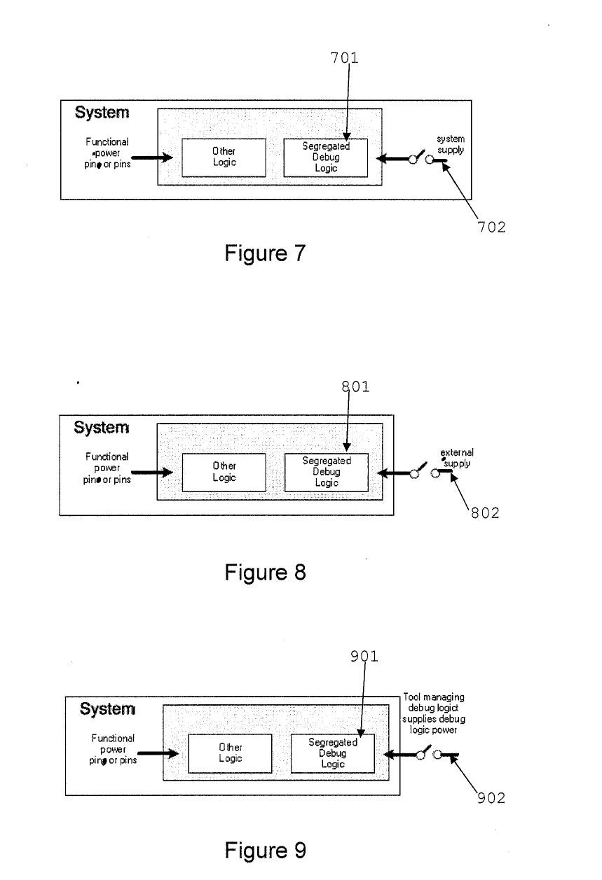

Using segregate debug logic 701 that is powered with segregated debug logic power pins required a power source be connected to these pins before the debug logic can be used. FIG. 7 shows debug logic 701 powered by system supply 702. FIG. 8 shows debug logic 802 powered by external supply 802, and FIG. 9 shows debug logic 901 powered by a pin 902 connected to an external tool managing the debug logic power supplies.

When debugging a system with separately powered debug logic via a functional interface such as USB or a connection to debug logic via a dedicated debug interface like JTAG(IEEE 1149.1), or cJTAG(IEEE 1149.7), it is desirable that these interfaces supply the power for the debug logic, although an external supply can also be used while using any interface providing debug communication.

What is claimed is:

1. A system of supplying power to dedicated debug logic in an SoC comprising:
one or more segregated power pins dedicated to directly powering said debug logic.

2. The system of claim 1, wherein:
said segregated power pins receive power from an external power source.

3. The system of claim 1, wherein:
said segregated power pins receive power from the system power source.

4. The system of claim 1, wherein:
said segregated power pins receive power from a debug communication system.

5. The system of claim 1, wherein:
said segregated power pins receive power from an external debug power management system.

6. The system of claim 1, further comprising:
one or more segregated power pins dedicated to directly supplying power to embedded power management logic that is operable to manage the power to the debug logic.

7. The system of claim 6, wherein:
said segregated power pins receive power from an external power source.

8. The system of claim 6, wherein:
said segregated power pins receive power from the system power source.

9. The system of claim 6, wherein:
said segregated power pins receive power from a debug communication system.

10. The system of claim 6, wherein:
said segregated power pins receive power from an external debug power management system.
